(19) United States
(12) Patent Application Publication
(10) Pub. No.: US 2005/0098183 A1
(43) Pub. Date: May 12, 2005

(54) Face masks

(76) Inventors: John Nash, Hythe (GB); Lois Rebecca Williams, Hythe (GB); Simon Neame, Broadstairs (GB); Eric Pagan, Hythe (GB); Giles Andrew Bishop, Canterbury (GB); David Bower, Herne Bay (GB); Clive Stinton, Folkestone (GB)

Correspondence Address: LOUIS WOO;LAW OFFICE OF LOUIS WOO, 717 NORTH FAYETTE STREET, ALEXANDRIA, VA, 22314, US

(21) Appl. No.: 10/749,513

(22) Filed: Jan. 2, 2004

(30) Foreign Application Priority Data
Jan. 15, 2003 (GB) 0300875.2

(51) Int. Cl. A62B 18/02; A62B 18/08

(52) U.S. Cl. 128/206.21; 128/206.27

(57) ABSTRACT

A face mask has a relatively soft canopy and a more rigid reinforcement member moulded together from different plastics as two shots in a dual-shot moulding process. The peripheral sealing edge of the canopy is tapered to a reduced thickness to increase its flexibility. The reinforcement member is a frame with radially-extending arms supporting respectively a gas port by which gas can enter the mask, a valve that allows air into the mask when there is an inadequate supply at the gas port and a selectively closable vent. The mask is secured to the patient's head by a harness attached to ends of the harness arms.

### BACKGROUND OF THE INVENTION

This invention relates to face masks.

Face masks are used to supply gas to a patient for various purposes and are designed to seal with the skin surface around the nose and mouth. There are many different forms of face mask currently available but often these suffer from disadvantages such as large bulk, weight, discomfort in use or poor sealing.

### BRIEF SUMMARY OF THE INVENTION

It is an object of the present invention to provide an alternative face mask.

According to one aspect of the present invention there is provided a face mask of a plastics material comprising a relatively soft canopy member having a peripheral sealing edge providing a seal with the skin around the nose and mouth of a patient, the canopy member being moulded as one shot in a dual-shot moulding process, a relatively rigid reinforcement member being moulded integrally with the canopy member as another shot in the dual-shot moulding process, and the mask having a gas port by which gas can enter the mask.

The peripheral sealing edge of the canopy preferably is tapered to a reduced thickness and an increased flexibility at its edge. The gas port is preferably provided on the reinforcement member. The gas port may have a connector projecting therefrom for connection to a gas supply tube, the port being located in line with the mouth of the patient and the connector being angled such that it projects down when the mask is applied to the patient's face in an upright position. The face mask preferably includes a valve separate from the gas port, the valve being arranged to allow air to flow into the mask when there is an inadequate supply at the gas port. The valve may be provided on the reinforcement member. The mask preferably includes selectively closable vent means that can be opened to allow flow of gas out of the mask, and the vent means may include a cap member movable between two discrete positions where the vent is open or closed respectively. The vent means is preferably provided on the reinforcement member. The reinforcement member is preferably a frame with a plurality of radially-extending arms. Two of the arms may extend towards opposite edges of the mask and be terminated by lateral bars extending substantially parallel to the edge of the mask. The lateral bars may support fastening means for a harness extending around the head of the patient. The mask preferably includes three arms supporting respectively a gas port, a valve to allow gas to enter the mask and a vent that can be opened to allow gas to flow out of the mask. The mask may include a harness adapted to extend around the head of the patient and attached at opposite ends with the reinforcement member. Opposite ends of the harness may be of triangular shape having a free end extending rearwardly, the free end being adjustably attachable with a part of the harness.

According to another aspect of the present invention there is provided a method of making a face mask comprising the steps of moulding a first component in a mould from a relatively high temperature plastics material and subsequently moulding a second component from a relatively low temperature plastics material directly on the first component while the first component is in the mould.

According to a further aspect of the present invention there is provided a face mask made by a method according to the above other aspect of the invention.

A face mask according to the present invention will now be described, by way of example, with reference to the accompanying drawings.

### BRIEF DESCRIPTION OF THE DRAWINGS

FIG. 1 is a front view of the mask;

FIG. 2 is a side elevation view of the mask on the face of a patient;

FIG. 3 is a sectional side elevation view of the mask;

FIGS. 4 and 5 are sectional side elevation views of a part of the mask to an enlarged scale indicating how it seals on the face;

FIG. 6 is a perspective view of a controlled leak device;

FIG. 7 is a sectional side elevation view of an anti-asphyxia valve;

FIG. 8 shows two straps used in the mask harness;

FIG. 9 is a side elevation view of the mask showing an alternative harness;

FIG. 10 is an elevation view of the edge of the mask showing a tube access; and

FIG. 11 is a sectional view of the tube access of FIG. 10.

### DETAILED DESCRIPTION OF THE PREFERRED EMBODIMENTS

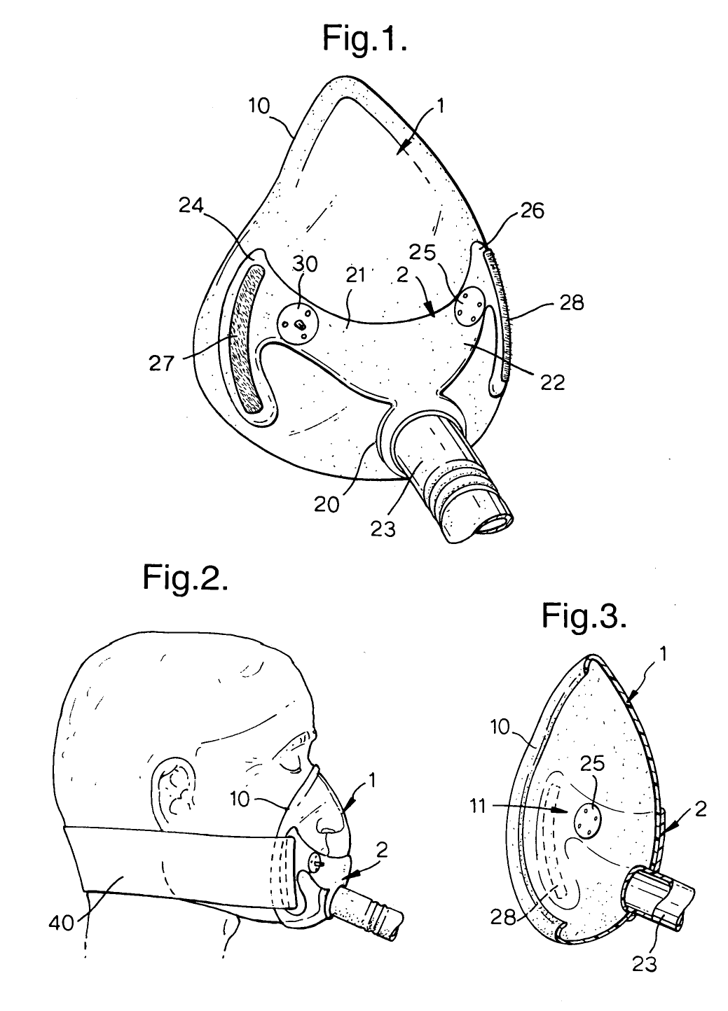

With reference first to FIGS. 1 to 5, the mask comprises two parts, namely a canopy 1 and a support frame 2. The canopy 1 is moulded of a relatively soft, flexible plastics material, such as, SEBS styrene ethylene butadiene styrene, whereas the support frame 2 is moulded of a harder material, such as a polypropylene copolymer. The canopy 1 and support frame 2 are moulded integrally with one another by a dual-shot moulding process in which the higher temperature plastics material forming the frame 2 is moulded first in a mould cavity, then the mould is enlarged to form a cavity for the canopy, which is subsequently moulded from a lower temperature plastics material. This results in the canopy and support frame being integrally bonded together.

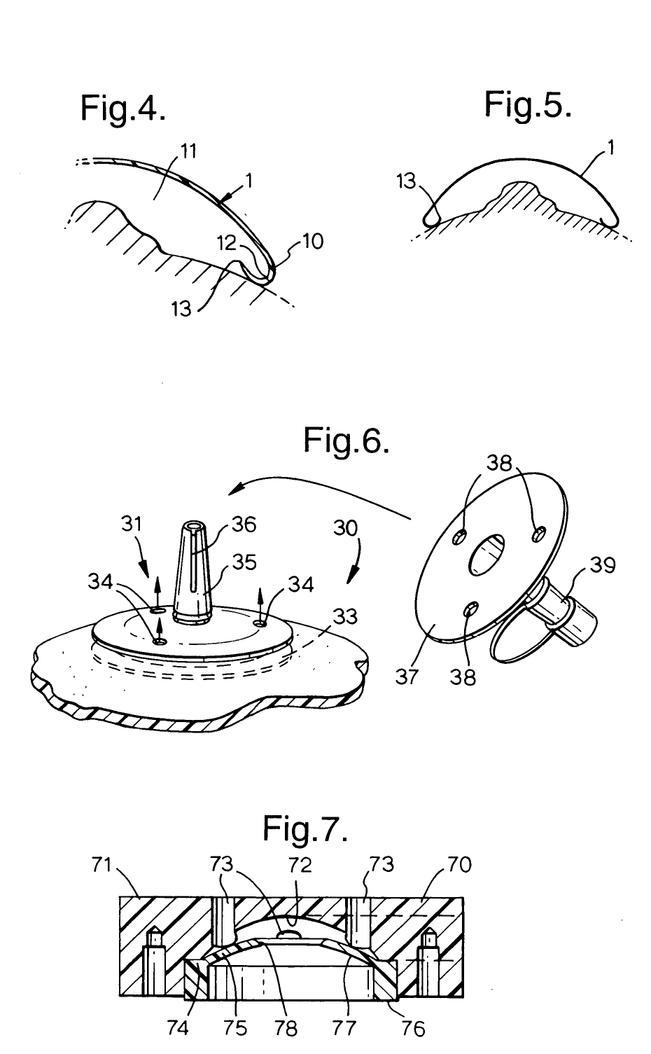

The canopy 1 is of generally triangular shape with a peripheral edge 10 shaped to extend under the mouth, up the cheeks, along the sides and across the nose. The canopy 1 has a domed internal cavity 11 in which the nose is received. The edge 10 is curved inwardly into the cavity in a C shape so that, when the mask is placed against the face, as shown in FIGS. 4 and 5, a curved contact region 12 contacts the skin with the lip 13 being on or spaced slightly above the skin. The canopy 1 varies in thickness from about 2 mm across most of its surface tapering to about 1.5 mm in the contact region 12 and to about 0.7 mm at the lip 13. This makes the edge 10 very flexible. The seal with the patient's skin could be further enhanced by an adhesive material on the contact region.

The frame member 2 has a generally star shape with three radially-extending arms 20, 21 and 22. One arm 20 projects down and is formed with a gas connector port 23 positioned in line with the patient's mouth and angled downwardly at an angle of about 20° to the horizontal when mounted on the patient's face in an upright position. A second arm 21 projects upwardly to the left, as viewed in FIG. 1, and includes a controlled leak device 30 to be described in greater detail later. The second arm 21 is terminated by a lateral bar 24 extending parallel to the edge of the mask in the region of the patient's right cheek. The third arm 22 projects upwardly towards the right and includes an anti-asphyxia valve 25, as described in greater detail later. The third arm is terminated by a lateral bar 26 extending parallel to the edge of the mask in the region of the patient's left cheek.

Moulding the face mask in a dual-shot process gives various advantages. It enables the mask to made very thin and light in weight with a very flexible seal whilst having sufficient rigidity across its central portion to support the connector and the various other components without deformation. Because the mask can be made thin, the upper part of the mask can be shaped to follow closely the profile of the nose. This reduces interference to the patient's eyesight and can make the mask less claustrophobic than some previous masks. The dual-shot process also enables the mask to be made with high transparency so that the part of the face enclosed by the mask can be seen clearly by the clinician.

The controlled leak device 30 is shown most clearly in FIGS. 6 and 7 and is formed of two components, namely a base 31 and a cap 32. The base 31 comprises a circular plate 33 secured in an aperture in the frame 2. The plate 33 has three gas passages 34 extending through it and a central stem 35 projecting from the external surface. The stem 35 is hollow and cylindrical with a male luer slip surface to receive a female connector. The stem 35 also has key formations 36 on its outer surface. The cap 32 has a plate 37 of the same diameter as the base plate 33 and with three openings 38 spaced in the same manner as the passages 34. A hollow sleeve 39 projects from the centre of the plate 33. The sleeve 39 is shaped to fit on the stem 35 and has keyway formations on its inner surface (not shown). The key and keyway formations are arranged to prevent rotation of the cap 32 on the base 31 and to ensure that the cap can only be fitted on the base either with the openings 38 aligned with the gas passages 34 or with them not aligned and thereby preventing flow of gas. When the cap 32 is mounted on the base with the openings 38 aligned with the gas passages this permits a small flow of gas through the leak device. This is sufficient to allow air exhaled by the patient to flow out through the leak without enabling pressure of gas supplied to the mask to fall below the level needed for CPAP ventilation. When the cap 32 is removed, a tube (not shown) can be connected to the tapered stem 35 for carbon dioxide sampling purposes.

The anti-asphyxia valve 25 is shown in FIG. 7 and includes a rigid plate 70, which is flat on its upper, outer surface 71 and has a concave, domed recess 72 on its lower, inner surface. Four holes 73 extend through the plate 70 between the recess 72 and the outer surface 71 and are equally distributed around the edge of the recess. A narrow ledge 74 extends around the outside of the recess 72. The valve 25 also includes a flexible, resilient diaphragm 75 providing a valve member for the valve. The diaphragm 75 has a peripheral ledge 76, which is clamped on the ledge 74 by a ring (not shown), and a domed central portion 77 with a central aperture 78. The radius of curvature of the domed portion 77 in its natural state is greater than that of the recess 72 so that it is spaced away from the recess and allows free flow of gas through the aperture 78 and holes 73. When the internal pressure within the mask is raised, the domed portion 77 is forced outwardly, that is, upwardly into contact with the recess 72, thereby sealing the holes 73 closed. The valve 25, therefore, closes when there is high gas pressure within the mask but opens when gas pressure drops, thereby permitting the patient to breath atmospheric air in through the valve. Other, conventional forms of valve could be used to allow the patient to inhale via the valve should there be an obstruction to gas flow to the inlet port 23. Previous anti-asphyxia valves have been incorporated into the gas inlet port connection but this has the disadvantage of increasing the bulk at the inlet and thereby increasing the bending moment exerted on the mask by the associated inlet tubing.

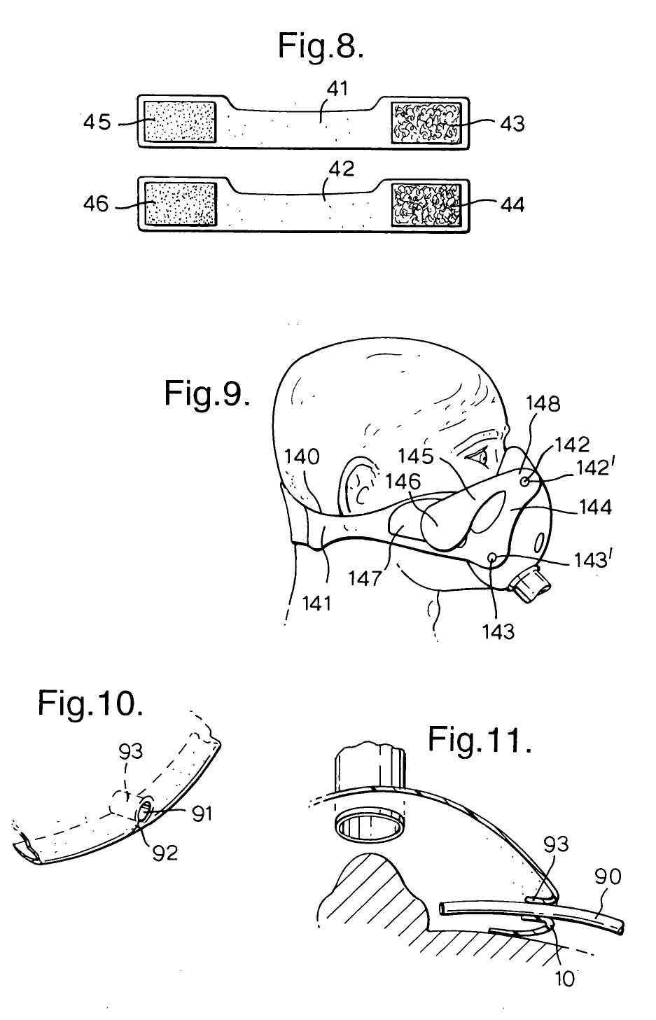

Attached to both lateral bars 24 and 26 is a strip 27 and 28 of a hook fastening material, such as of the kind sold under the Velcro trade mark (Velcro is a Registered Trade Mark of Velcro BV), which is used to secure an end of a harness 40. The harness 40 comprises two flexible, elastic straps 41 and 42, as shown in FIG. 8, which both have a pad 43 and 44 of a loop fastening material at one end so that they can be secured with the strips 27 and 28 on the mask frame 2. At their other ends, one strap 41 has a pad 45 of a hook material and the other strap 42 has a pad 46 of a loop material. Opposite ends of the straps 41 and 42 are enlarged laterally to accommodate the pads 43 to 46. In this way, the straps 41 and 42 can be secured with one another at one end at the back of the patient's head and can be secured at their other ends with the mask frame 2. The arrangement allows for the straps to be secured to the frame and to one another at any angle, thereby allowing flexibility in positioning of the harness so as to accommodate a variety of patients.

An alternative harness arrangement 140 is illustrated in FIG. 9. This harness 140 has two straps 141, only one of which is shown, which are fastened together at the back of the head by hook and loop fastening material (not shown). The straps 141 are fastened to the mask itself by means of two posts 142 and 143 projecting from the side of the mask and spaced one above the other, which extend through apertures 142′ and 143′ in the straps. The forward end of the straps 141 is of triangular shape having a lateral portion 144 extending upwardly at an angle of about 90° to the main part of the strap, and a rearwardly-extending portion 145 extending rearwardly and downwardly at an angle of about 45° to the upper end of the lateral portion. The rearwardly-extending portion 145 has a free rear end to which is attached a pad 146 of a hook or loop material, which attaches to a cooperating pad 147 on the main part of the strap. This arrangement enables the pressure exerted by the mask on the face to be adjusted to alter its distribution. Pressure exerted by the upper part of the mask can be increased or reduced by appropriately moving the end of the portion 145 to attach it to a part of the pad 147 that is further back or further forwards. The straps 141 each have a quick-release tab 148 in the region of the upper aperture 142′. One or both of these tabs 148 can be pulled down to release the harness 141 from the mask.

Various modifications are possible to the mask. The edge seal of the mask may be modified to allow a nasogastric tube 90 to pass through the edge 10, as shown in FIGS. 10 and 11. In this arrangement the edge of the mask is moulded with a keyhole-shape formation 91 of reduced thickness, which can be easily torn or cut. The keyhole-shape formation 91 has a very narrow entrance portion slit 92 extending to the edge, and a circular sleeve portion 93 located above it and projecting a short distance inwardly. When used without a nasogastric tube, this formation is left in place so that there is no path for gas leakage in this region. When a nasogastric tube is to be used, the keyhole-shape formation is torn or cut to form a keyhole-shape aperture so that the tube 90 can be pushed sideways in through the narrow part of the aperture, which may be self-closing, and located in the circular, sleeve part of the aperture where it is a close, sealing fit. If the mask needs to be removed at any time, the tube can be easily peeled out of the aperture so that its patient end can be left in place in the patient and its machine end need not be disconnected from any apparatus to which it is connected. The mask can be subsequently replaced on the patient after having pushed the nasogastric tube into the aperture.

1. A face mask of a plastics material comprising: a relatively soft canopy member having a peripheral sealing edge providing a seal with the skin around the nose and mouth of a patient, said canopy member being moulded as one shot in a dual-shot moulding process; a relatively rigid reinforcement member, said reinforcement member being moulded integrally with said canopy member as another shot in the dual-shot moulding process; and a gas port by which gas can enter the mask.

2. A face mask according to claim 1, wherein said peripheral sealing edge of said canopy member is tapered to a reduced thickness and an increased flexibility at its edge.

3. A face mask according to claim 1, wherein said gas port is provided on said reinforcement member.

4. A face mask according to claim 1, wherein said gas port has a gas connector projecting therefrom for connection to a gas supply tube, and wherein said port is located in line with the mouth of the patient and said connector is angled such that it projects down when the mask is applied to the patient's face in an upright position.

5. A face mask according to claim 1 including a valve separate from said gas port, wherein said valve is arranged to allow air to flow into the mask when there is an inadequate supply at said gas port.

6. A face mask according to claim 5, wherein said valve is provided on said reinforcement member.

7. A face mask according to claim 1 including a selectively closable vent that can be opened to allow flow of gas out of the mask.

8. A face mask according to claim 7, wherein said vent includes a cap member movable between two discrete positions where said vent is open or closed respectively.

9. A face mask according to claim 7, wherein said vent is provided on said reinforcement member.

10. A face mask according to claim 1, wherein said reinforcement member is a frame with a plurality of radially-extending arms.

11. A face mask according to claim 10, wherein two of said arms extend towards opposite edges of mask and are terminated by lateral bars extending substantially parallel to an edge of the mask.

12. A face mask according to claim 11 including a harness arranged to extend around the head of the patient, and wherein said lateral bars support a fastener to which said harness is attached.

13. A face mask according to claim 10, wherein said frame includes three arms supporting respectively a gas port, a valve to allow gas to enter the mask and a vent that can be opened to allow gas to flow out of the mask.

14. A face mask according to claim 1 including a harness arranged to extend around the head of the patient and wherein said harness is attached at opposite ends with said reinforcement member.

15. A face mask according to claim 14, wherein the opposite ends of said harness are of triangular shape having a free end extending rearwardly and wherein the free end is adjustably attachable with a part of said harness.

16. A face mask assembly including a harness and a mask, wherein said mask is of a plastics material and comprises: a relatively soft canopy member having a peripheral sealing edge providing a seal with the skin around the nose and mouth of a patient, said canopy member being moulded as one shot in a dual-shot moulding process; a relatively rigid reinforcement member, said reinforcement member being moulded integrally with said canopy member as another shot in the dual-shot moulding process; and a gas port provided on said reinforcement member by which gas can enter the mask, and wherein said harness is arranged to extend around the head of the patient and is attached with said reinforcement member.

17. A face mask assembly according to claim 16, wherein said mask includes a valve on said reinforcement member and separate from said gas port, said valve being arranged to allow air to enter the mask when there is an inadequate supply at said gas port, and wherein said mask includes a selectively closable vent provided on said reinforcement member, said vent being openable to allow gas out of the mask.

18. A method of making a face mask comprising the steps of: moulding a first component in a mould from a relatively high temperature plastics material and subsequently moulding a second component from a relatively low temperature plastics material directly on said first component while said first component is in said mould.
